(19) United States
(12) Patent Application Publication
(10) Pub. No.: US 2018/0207773 A1
(43) Pub. Date: Jul. 26, 2018

(54) Hand tool with dual wrenching modes

(71) Applicant: Richard J. Macor, Hunterdon County, NJ (US)

(72) Inventor: Richard J. Macor, Hunterdon County, NJ (US)

(21) Appl. No.: 15/530,538

(22) Filed: Jan. 25, 2017

(51) Int. Cl. B25B 23/00; B25B 13/46; B25G 1/06

(52) U.S. Cl. CPC B25B 23/0028; B25G 1/063; B25B 13/46

(57) ABSTRACT

A hand tool that has a tool head with at least two jaws. Each jaw has at least one internal engaging surface for engaging with a work-piece such as a nut or bolt that has an axis of rotation. The at least one internal engaging surface of each jaw extends in a direction creating an imaginary line when the hand tool is viewed from a side view thereof. The hand tool also has a handle which extends from the tool head. The handle has a front portion and a rear portion. The hand tool also has a ratcheting means which provides ratcheting capability to the tool head when the handle is twisted back and forth by a user. The ratcheting means has an axis of rotation substantially parallel to the imaginary line created by the at least one internal engaging surface of at least one jaw when the hand tool is viewed from a side view thereof.

### REFERENCES TO RELATED APPLICATIONS

This patent application is a “continuation-in-part” (CIP) of U.S. patent application Ser. No. 14/998,940 filed by the same inventor herein.

### FIELD OF THE INVENTION

The present invention relates to hand operated tools that have a tool head and at least two jaws for turning a work-piece such as a nut and/or bolt. More specifically, the present invention relates to wrenches, pliers, locking pliers, and the like.

### BACKGROUND OF THE INVENTION

Hand tools including wrenches, pliers, locking pliers and the like have been popular with users for decades. Some of the traditional, prior art hand tools and wrenches include a ratcheting mechanism with a rotational axis that is generally perpendicular to the direction at which the handle is elongated. The present invention provides users with multiple operational benefits yet is structurally and functionally distinct from prior art hand tools and wrenches.

### SUMMARY OF THE INVENTION

A hand tool that has a tool head with at least two jaws. Each jaw has at least one internal engaging surface for engaging with a work-piece such as a nut or bolt which has an axis of rotation. The at least one internal engaging surface of each jaw extends in a direction creating an imaginary line when the hand tool is viewed from a side view thereof. The hand tool also has a handle which extends from the tool head. The handle has a front portion and a rear portion. The hand tool also has a ratcheting means which provides ratcheting capability to the tool head when the handle is twisted back and forth by a user. The ratcheting means has an axis of rotation substantially parallel to the imaginary line created by the at least one internal engaging surface of at least one jaw when the hand tool is viewed from a side view thereof.

It is an objective of the present invention described herein that it provides a user with the novel benefit of a second wrenching mode, whereby, a user may “run” a work-piece with a ratcheting means when high torque is not required.

It is another objective of the present invention described herein that it provides a ratcheting means for use in the second wrenching mode to expedite the removal and/or installation of a work-piece such as a nut or bolt.

It is another objective of the present invention described herein that it provides improved accessibility in tight work spaces.

And, it is another objective of the present invention described herein that it's commercially viable, simple in design, and cost-efficient to manufacture.

### BRIEF DESCRIPTION OF THE DRAWINGS

The present invention is more fully understood when the specification herein is taken in conjunction with the drawings appended hereto, wherein:

FIG. 1 shows a left side, elevation view of an example embodiment of an adjustable wrench engaging with a hexagonal nut while used in a first wrenching mode;

FIG. 2 shows the same adjustable wrench shown in FIG. 1 engaging with the same hexagonal nut while used in a second wrenching mode;

FIG. 3 shows a left side, elevation view of another example embodiment of an adjustable wrench engaging with a hexagonal nut while used in a first wrenching mode;

FIG. 4 shows the same adjustable wrench shown in FIG. 3 engaging with the same hexagonal nut while used in a second wrenching mode;

FIG. 5 shows a left side, elevation view of an example embodiment of an open-end wrench engaging with a hexagonal nut while used in a first wrenching mode;

FIG. 6 shows the same wrench shown in FIG. 5 engaging with the same hexagonal nut while used in a second wrenching mode;

FIG. 7 shows a cut, front perspective elevation view of an example embodiment of an open-end wrench;

FIG. 8 shows a front, elevation view of the open-end wrench shown in FIG. 7 engaging with a hexagonal nut.

FIG. 9 shows a left side elevational view of an example embodiment of an adjustable wrench;

FIG. 10 shows the same adjustable wrench shown in FIG. 9 but with the outer handle cut away to expose the inner handle and ratcheting means of the wrench;

FIG. 11 shows a left side elevational view of an example embodiment of a locking adjustable wrench that includes a clamping means for clamping its jaws upon a work-piece.

FIG. 12 shows a left side elevational view of an example embodiment of a locking pliers that includes a clamping means for clamping its jaws upon a work-piece.

### DETAILED DESCRIPTION OF THE DRAWINGS

The various drawings provided herein are for the purpose of illustrating examples of the present invention and not for the purpose of limiting same. Therefore, the drawings herein represent only a few of the many possible examples, embodiments, variations and/or applications of the present invention.

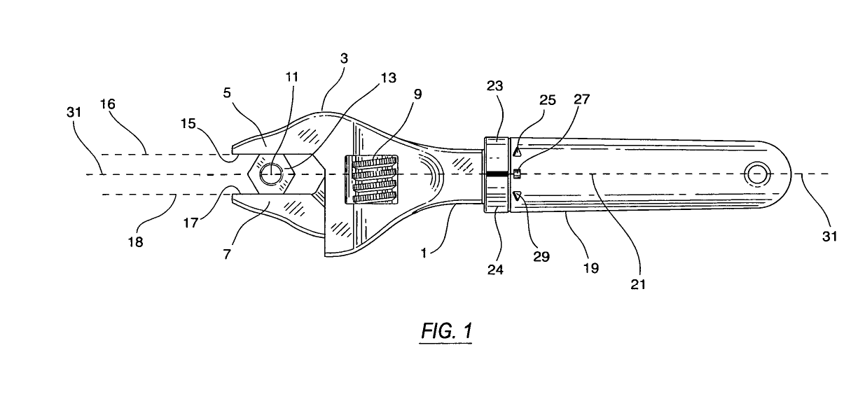

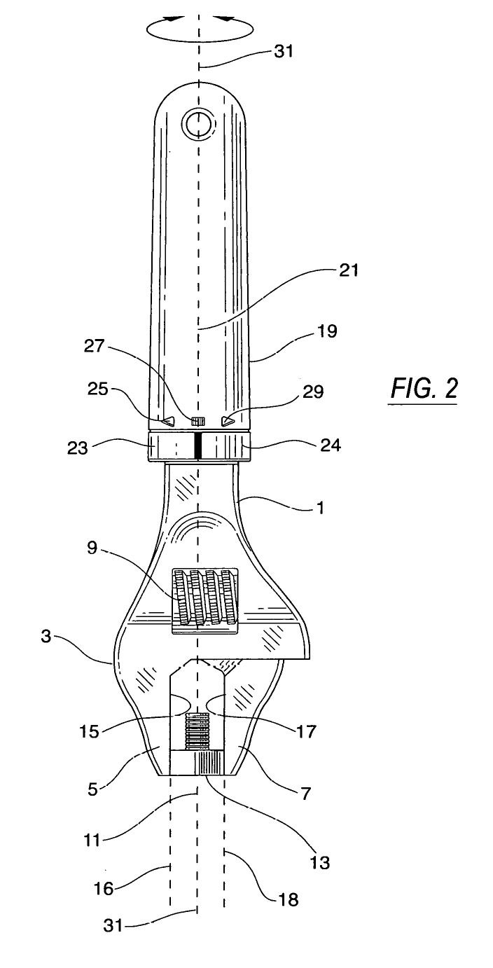

Referring now to FIGS. 1 and 2 together, FIG. 1 shows a left side, elevation view of an example embodiment of an adjustable wrench engaging with a hexagonal nut while used in a first wrenching mode; and, FIG. 2 shows the same adjustable wrench shown in FIG. 1 engaging with the same hexagonal nut while used in a second wrenching mode. Adjustable wrench 1 has an open-end wrench head 3 with two jaws 5 and 7, and an adjustment means 9. Adjusting means 9 may be turned to adjust space between jaws 5 and 7. The adjustable wrench versions of the present invention are formed so that at least one jaw is movable relative to the other jaw via an adjustment means. In this embodiment of the present invention, jaw 5 is fixed and jaw 7 is movable via adjustment means 9. However, the present invention adjustable wrench could also be configured with two moving jaws that move separately or simultaneously via an adjustment means or mechanism. Each jaw 5 and 7 has at least one internal engaging surface for engaging with a work-piece such as a nut, bolt, fastener, etc. Jaw 5 has an internal engaging surface 15; and, jaw 7 has an internal engaging surface 17. In this case, each jaw 5 and 7 has only one internal engaging surface for engaging with a work-piece, however, the present invention wrenches may have one jaw or both jaws with multiple engaging surfaces. Each internal engaging surface 15 and 17 creates an imaginary line when the wrench is viewed from a side view thereof. As seen in this left side view, engaging surface 15 of jaw 5 creates imaginary line 16; and, engaging surface 17 of jaw 7 creates imaginary line 18.

Shown in FIG. 1, engaging surfaces 15 and 17 of jaws 5 and 7 respectively, are engaged with a work-piece 13 (a hexagonal nut) wherein wrench 1 is pulled or pushed to turn work-piece 13 about axis of rotation 11. Wrench 1 is then disengaged, reoriented, and re-engaged to turn work-piece 13. This is a typical, first mode of usage for the present invention wrench 1. Wrench 1 also has a handle 19 extending from wrench head 3 and is elongated in a predetermined direction which defines central axis 21. The present invention may have a handle with one or more sections elongated in one or more different predetermined directions defining one or more handle central axes. In this case, handle 19 extends from wrench head 3 and is elongated in only one predetermined direction defining only one central axis 21.

Wrench 1 also has a ratcheting means 23 providing ratcheting capability between wrench head 3 and handle 19 when handle 19 is twisted clockwise or counter-clockwise. When referring to a “ratcheting means” applicant defines such means as any mean(s) or mechanism(s) including but not limited to gear(s) pawl(s) clutch(s) etc. that allow(s) for free rotation of a tool component in one direction while preventing free rotation of the tool component in the other direction. A heavy-duty version of the ratcheting mechanism using gear(s) and pawl(s) commonly found in ratcheting screwdrivers is contemplated. The ratcheting means 23 has an axis of rotation 31 that is substantially parallel to the imaginary line created by the at least one engaging surface of at least one wrench jaw of the wrench. In this case, the axis of rotation 31 of ratcheting means 23 is parallel to both the imaginary lines 16 and 18 of engaging surfaces 15 and 17 respectively.

As seen in FIG. 2, when wrench 1 is oriented for use in a second wrenching mode, a user can “run” a work-piece clockwise or counter-clockwise without the need to remove, re-orientate and re-engage the wrench with the work-piece by simply twisting handle 19 back and forth about the axis of rotation 31 of ratcheting means 23. To provide yet more versatility, ratcheting means 23 has a collar 24 which may be rotated into three different positions to control the direction of the ratcheting means, whereby, when collar 24 of ratcheting means 23 is rotated to align with marker 25, ratcheting means 23 is activated for clockwise rotation to run a work-piece during installation; and, if collar 24 of ratcheting means 23 is rotated to align with marker 29, ratcheting means 23 is activated for counter-clockwise rotation to run a work-piece during removal. And, if collar 24 of ratcheting means 23 is in the center position 27 (as shown), wrench head 3 and handle 19 are locked together and the ratcheting means is selectively deactivated.

As shown in FIGS. 1 and 2, to eliminate a wobble effect rotational axis 31 of ratcheting means 23 is substantially aligned with the center axis 21 of handle 19 to facilitate the second wrenching mode of wrench 1 to “run” a work-piece such as a nut or bolt, etc. more efficiently and quickly.

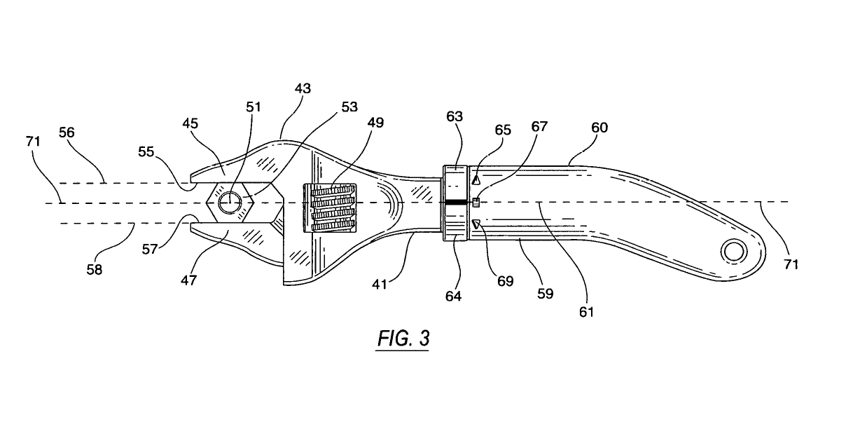

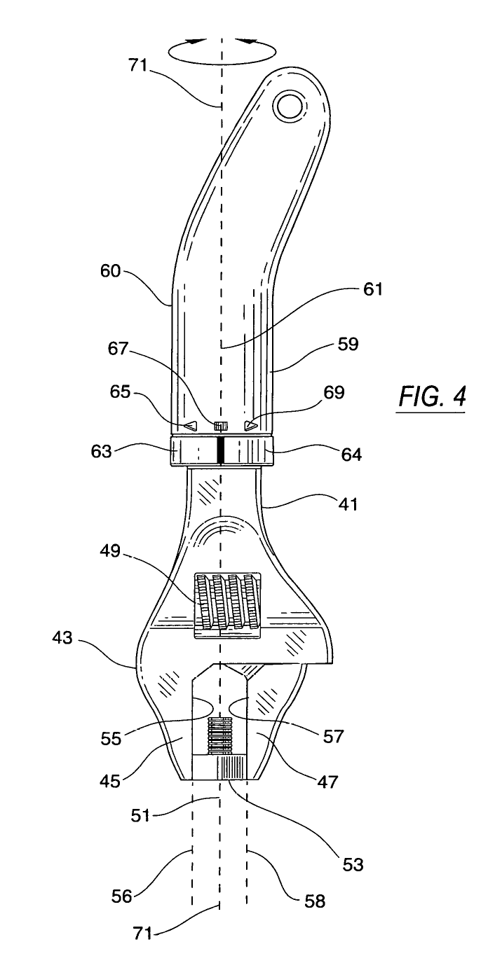

Referring now to FIGS. 3 and 4 together, FIG. 3 shows a left side, elevation view of an example embodiment of an adjustable wrench engaging with a hexagonal nut while used in a first wrenching mode; and, FIG. 4 shows the same adjustable wrench shown in FIG. 3 engaging with the same hexagonal nut while used in a second wrenching mode. Adjustable wrench 41 has an open-end wrench head 43 with two jaws 45 and 47, and an adjustment means 49. Adjusting means 49 may be turned to adjust space between jaws 45 and 47. The adjustable wrench versions of the present invention are formed so that at least one jaw is movable relative to the other jaw via an adjustment means. In this embodiment of the present invention jaw 45 is fixed and jaw 47 is movable via adjustment means 49. However, the present invention adjustable wrench could also be configured with two moving jaws that move separately or simultaneously via an adjustment means or mechanism. Each jaw 45 and 47 has at least one internal engaging surface for engaging with a work-piece such as a nut, bolt, fastener, etc. Jaw 45 has an internal engaging surface 55; and, jaw 47 has an internal engaging surface 57. In this case, each jaw 45 and 47 has only one internal engaging surface for engaging with a work-piece, however, the present invention wrenches may have one jaw or both jaws with multiple engaging surfaces. Each internal engaging surface 55 and 57 creates an imaginary line when the wrench is viewed from a side view thereof. As seen in this left side view, engaging surface 55 of jaw 45 creates imaginary line 56; and, engaging surface 57 of jaw 47 creates imaginary line 58.

Shown in FIG. 3, engaging surfaces 55 and 57 of jaws 45 and 47 respectively, are engaged with a work-piece 53 (a hexagonal nut) wherein wrench 41 is pulled or pushed to turn work-piece 53 about axis of rotation 51. Wrench 41 is then disengaged, reoriented, and re-engaged to turn work-piece 53. This is a typical, first mode of usage for the present invention wrench 41. Wrench 41 also has a handle 59 extending from wrench head 43 and is elongated in a predetermined direction which defines central axis 61. The present invention may have a handle with one or more sections elongated in one or more different predetermined directions defining one or more handle central axes. In this embodiment, handle 59 has an elongated section 60 extending from the wrench head 43 which is elongated in a predetermined direction defining central axis 61 of handle 59. Wrench 41 also has a ratcheting means 63 providing ratcheting capability between wrench head 43 and handle 59 when handle 59 is twisted clockwise or counter-clockwise. When referring to a “ratcheting means” applicant defines such means as any mean(s) or mechanism(s) including but not limited to gear(s) pawl(s) clutch(s) etc. that allow(s) for free rotation of a tool component in one direction while preventing free rotation of the tool component in the other direction. A heavy-duty version of the ratcheting mechanism using gear(s) and pawl(s) commonly found in ratcheting screwdrivers is contemplated. The ratcheting means 63 has an axis of rotation 71 that is substantially parallel to the imaginary line created by the at least one engaging surface of at least one wrench jaw of the wrench. In this case, the axis of rotation 71 of ratcheting means 63 is parallel to both the imaginary lines 56 and 58 of engaging surfaces 55 and 57 respectively.

As seen in FIG. 4, when wrench 41 is oriented for use in a second wrenching mode, a user can “run” a work-piece clockwise or counter-clockwise without the need to remove, re-orientate and re-engage the wrench with the work-piece by simply twisting handle 59 back and forth about the axis of rotation 71 of ratcheting means 63. To provide yet more versatility, ratcheting means 63 has a collar 64 which may be rotated into three different positions to control the direction of the ratcheting means, whereby, when collar 64 of ratcheting means 63 is rotated to align with marker 65, ratcheting means 63 is activated for clockwise rotation to run a work-piece during installation; and, if collar 64 of ratcheting means 63 is rotated to align with marker 69, ratcheting means 63 is activated for counter-clockwise rotation to run a work-piece during removal. And, if collar 64 of ratcheting means 63 is in the center position 67 (as shown), wrench head 43 and handle 59 are locked together and the ratcheting means is selectively deactivated.

As shown in FIGS. 3 and 4, to eliminate a wobble effect rotational axis 71 of ratcheting means 63 is substantially aligned with the center axis 61 of handle 59 to facilitate the second wrenching mode of wrench 41 to “run” a work-piece such as a nut or bolt, etc. more efficiently and quickly.

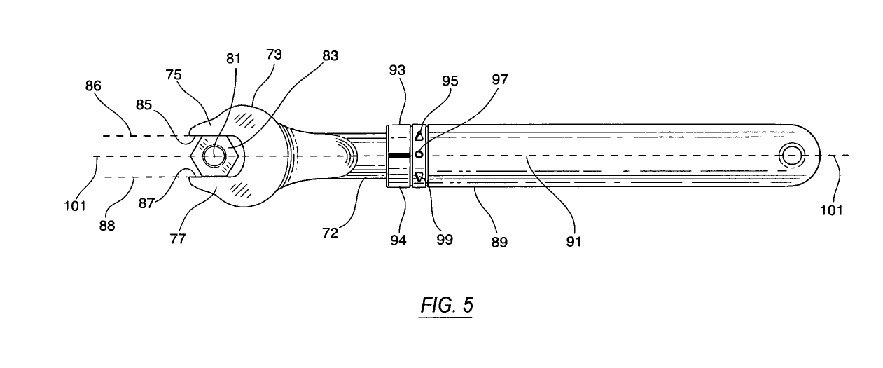

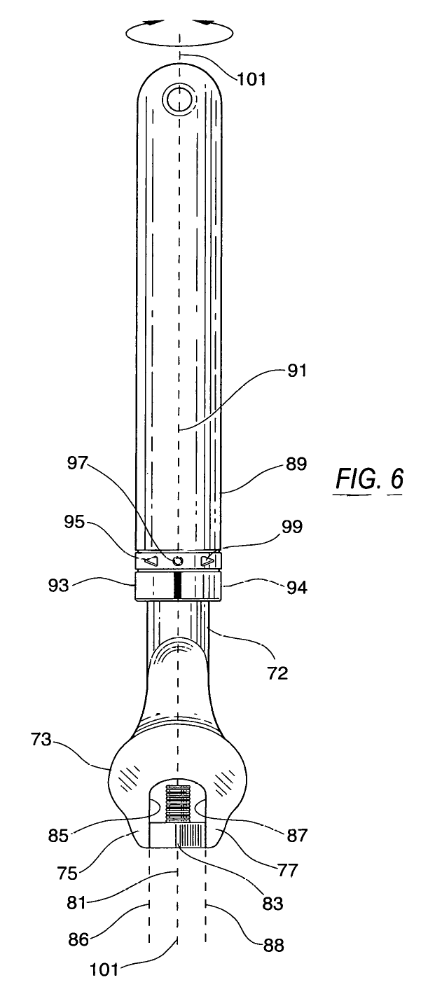

Referring now to FIGS. 5 and 6 together, FIG. 5 shows a left side, elevation view of an example embodiment of an open-end wrench engaging with a hexagonal nut while used in a first wrenching mode; and, FIG. 6 shows the same open-end wrench shown in FIG. 5 engaging with the same hexagonal nut while used in a second wrenching mode. Open-end wrench 72 has an open-end wrench head 73 with two jaws 75 and 77. Each jaw 75 and 77 has at least one internal engaging surface for engaging with a work-piece such as a nut, bolt, fastener, etc. Jaw 75 has an internal engaging surface 85; and, jaw 77 has an internal engaging surface 87. In this case, each jaw 75 and 77 has only one internal engaging surface for engaging with a work-piece, however, the present invention wrenches may have one jaw or both jaws with multiple engaging surfaces. Each internal engaging surface 85 and 87 creates an imaginary line when the wrench is viewed from a side view thereof. As seen in this left side view, engaging surface 85 of jaw 75 creates imaginary line 86; and, engaging surface 87 of jaw 77 creates imaginary line 88.

Shown in FIG. 5, engaging surfaces 85 and 87 of jaws 75 and 77 respectively, are engaged with a work-piece 83 (a hexagonal nut) wherein wrench 72 is pulled or pushed to turn work-piece 83 about axis of rotation 81. Wrench 72 is then disengaged, reoriented, and re-engaged to turn work-piece 83. This is a typical, first mode of usage for the present invention wrench 72. Wrench 72 also has a handle 89 extending from wrench head 73 and is elongated in a predetermined direction which defines central axis 91. The present invention may have a handle with one or more sections elongated in one or more different predetermined directions defining one or more handle central axes. In this case, handle 89 extends from wrench head 73 and is elongated in only one predetermined direction defining only one central axis 91. Wrench 72 also has a ratcheting means 93 providing ratcheting capability between wrench head 73 and handle 89 when handle 89 is twisted clockwise or counter-clockwise. When referring to a “ratcheting means” applicant defines such means as any mean(s) or mechanism(s) including but not limited to gear(s) pawl(s) clutch(s) etc. that allow(s) for free rotation of a tool component in one direction while preventing free rotation of the tool component in the other direction. A heavy-duty version of the ratcheting mechanism using gear(s) and pawl(s) commonly found in ratcheting screwdrivers is contemplated. The ratcheting means 93 has an axis of rotation 101 that is substantially parallel to the imaginary line created by at least one engaging surface of at least one wrench jaw of the wrench. In this case, the axis of rotation 101 of ratcheting means 93 is parallel to both the imaginary lines 86 and 88 of engaging surfaces 85 and 87 respectively.

As seen in FIG. 6, when wrench 72 is oriented for use in a second wrenching mode, a user can “run” a work-piece clockwise or counter-clockwise without the need to remove, re-orientate and re-engage the wrench with the work-piece by simply twisting handle 89 back and forth about the axis of rotation 101 of ratcheting means 93. To provide yet more versatility, ratcheting means 93 has a collar 94 which may be rotated into three different positions to control the direction of the ratcheting means, whereby, when collar 94 of ratcheting means 93 is rotated to align with marker 95, ratcheting means 93 is activated for clockwise rotation to run a work-piece during installation; and, if collar 94 of ratcheting means 93 is rotated to align with marker 99, ratcheting means 93 is activated for counter-clockwise rotation to run a work-piece during removal. And, if collar 94 of ratcheting means 93 is in the center position 97 (as shown), wrench head 73 and handle 89 are locked together and the ratcheting means is selectively deactivated.

As shown in FIGS. 5 and 6, to eliminate a wobble effect rotational axis 101 of ratcheting means 93 is substantially aligned with the center axis 91 of handle 89 extending from wrench head 73 to facilitate the second wrenching mode of wrench 72 to “run” a work-piece such as a nut or bolt, etc. more efficiently and quickly.

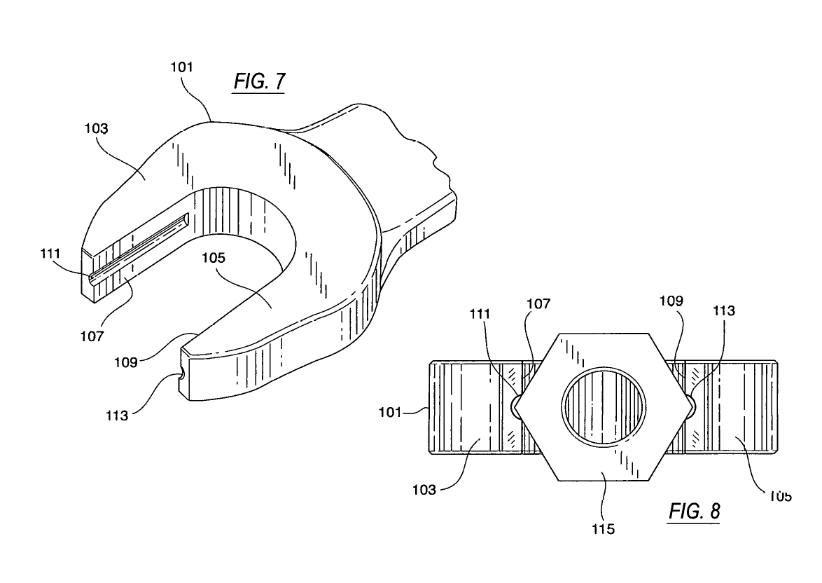

Referring now to FIGS. 7 and 8 together, FIG. 7 shows a cut, front perspective elevation view of an example embodiment of an open-end wrench; and, FIG. 8 shows a front, elevation view of the open-end wrench shown in FIG. 7 engaging with a hexagonal nut. Wrench head 101 has jaws 103 and 105. Jaws 103 and 105 have respective engaging surfaces 107 and 109. Each jaw 103 and 105 is elongated (longer than it is wide.) To enhance engagement between a work-piece and a wrench such as wrench 101 and work-piece 115 shown in FIG. 8, each of engaging surfaces 107 and 109 of jaws 103 and 105 respectively have a groove running to the distal end thereof. Engaging surface 107 of jaw 103 has groove 111 running to the distal end thereof; and, engaging surface 109 of jaw 105 has groove 113 running to the distal end thereof. As seen best in FIG. 8, the grooves help to control engagement with a work-piece when the wrench is used in the secondary wrenching mode also defined in FIGS. 2, 4, and 6 herein. If a user chose to engage the “flats” of a work-piece (instead of the “points”) with a present invention wrench, it would be advantageous to have least one engaging surface of at least one jaw (but preferably both jaws) roughened whereby the at least one engaging surface of one or both jaws is non-smooth. This could be achieved in many different ways including using a series of grooves or small ridges running in a lengthwise direction. Or, using a series of grooves or ridges formed in a cross pattern or another pattern. Or, using any form of a textured surface, sand blasted, etc., wherein at least one engaging surface of one or both jaws is non-smooth to increase the coefficient of friction between each engaging surface and the “flat(s)” of a work-piece to prohibit the wrench jaws from slipping off the work-piece while the ratcheting means is utilized by a user in the second mode of use.

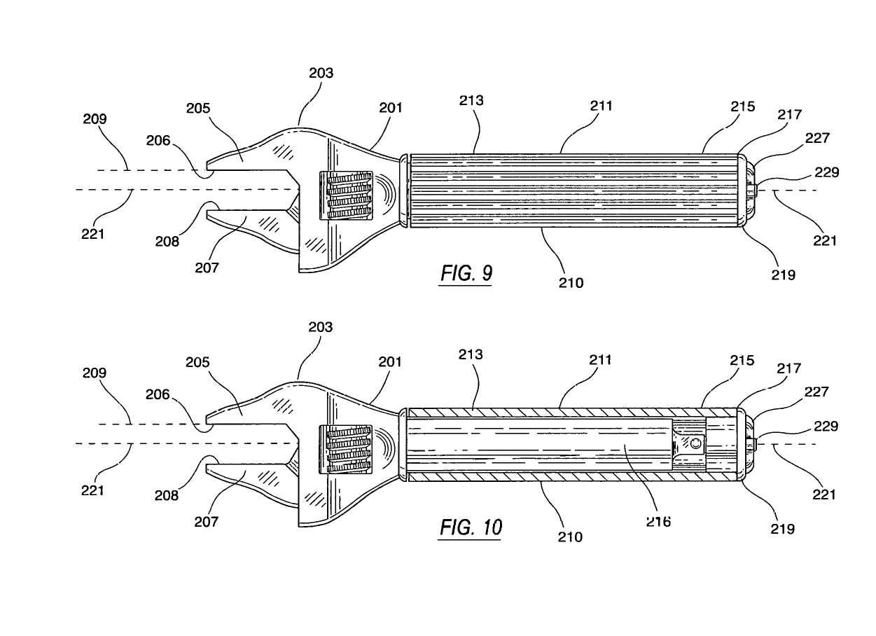

Referring now to FIGS. 9 and 10 together, FIG. 9 shows a left side elevational view of an example embodiment of an adjustable wrench; and, FIG. 10 shows the same adjustable wrench shown in FIG. 9 but with the outer handle cut away to expose the inner handle and ratcheting means of the wrench. Hand tool 201 (which in this embodiment is an adjustable wrench) has a wrench head 203 and wrench jaws 205 and 207. Each of jaws 205 and 207 has at least one internal engaging surface for engaging with a work-piece such as a nut or bolt having an axis of rotation. For example, jaw 205 has internal engaging surface 206; and, jaw 207 has internal engaging surface 208 as seen in this left side view of wrench 201. In this embodiment of the present invention, the at least one internal engaging surface of each jaw extends in a direction creating an imaginary line when hand tool 201 is viewed from a side view thereof. For example, internal engaging surface 206 of jaw 205 creates an imaginary line 209 as shown. Hand tool 201 also has a handle 211 extending from tool head 203. Handle 211 has front portion 213 and a rear portion 215; and, rear portion 215 has a rear end 217. In this example embodiment, handle 211 is comprised of a cylindrical outer part 210 which is cut away in FIG. 10 to show the inner workings of wrench handle 211, particularly inner wrench handle 216 connected to both wrench head 203 at one end and ratcheting means 219 at the other end. Ratcheting means 219 provides ratcheting capability to tool head 203 when handle 211 is twisted back and forth by a user. Ratcheting means 219 has an axis of rotation 221 that is substantially parallel to each of imaginary lines 209 and 221 created by internal engaging surface 206 of jaw 208 respectively as seen in this side view of hand tool 201. And, ratcheting means 219 is positioned within the rear portion 215 of handle 211. Positioning ratcheting means 219 at the rear portion of wrench handle 211 provides novel structural and functional benefits, whereas, the leverage forces applied to ratcheting means 219 are minimized. Leverage forces are most minimized when the ratcheting means 219 is positioned at the rear end 217 of handle 211 as shown. This ensures that ratcheting means 219 will not be adversely affected while high leverage forces are applied to the handle 211 of hand tool 201, thus maximizing the operational durability of ratcheting means 219. Ratcheting means 219 has a rotatable knob 227 for changing the rotational direction of the ratcheting action, and, a push button release 229 so ratcheting means 219 and outer handle 211 may be taken off inner handle 216.

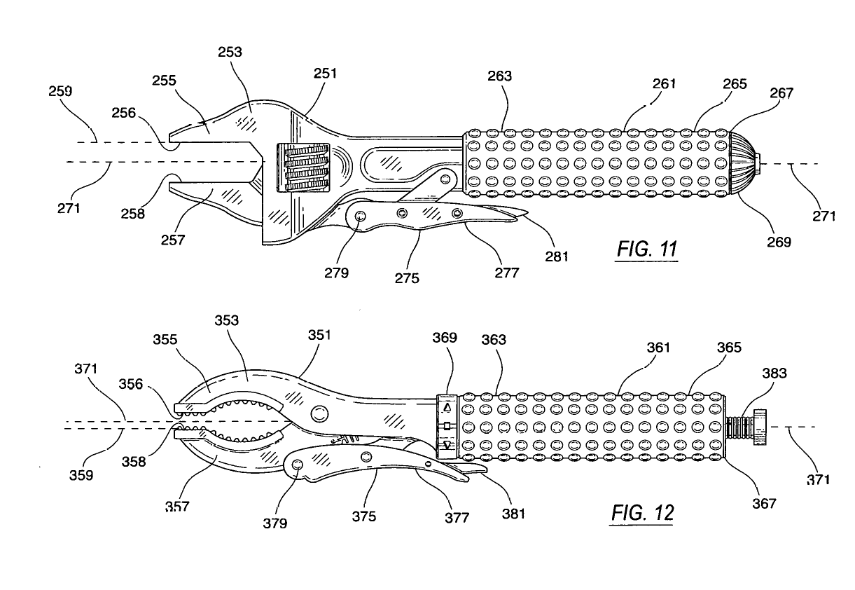

FIG. 11 shows a left side elevational view of an example embodiment of a locking adjustable wrench that includes a clamping means to close and clamp its jaws upon a work-piece. Hand tool 251 has a wrench head 253 and wrench jaws 255 and 257. Each of jaws 255 and 257 has at least one internal engaging surface for engaging with a work-piece such as a nut or bolt having an axis of rotation. For example, jaw 255 has internal engaging surface 256; and, jaw 257 has internal engaging surface 258 as seen in this left side view of wrench 251. In this embodiment of the present invention, the at least one internal engaging surface of each jaw extends in a direction creating an imaginary line when the hand tool 251 is viewed from a side view thereof. For example, internal engaging surface 256 of jaw 255 creates an imaginary line 259 as seen in this side view of hand tool 251. Hand tool 251 also has a handle 261 extending from tool head 253. Handle 261 has a front portion 263 and a rear portion 265; and, rear portion 265 has a rear end 267. Hand tool 251 also has a ratcheting means 269 providing ratcheting capability to tool head 253 when handle 261 is twisted back and forth by a user. Ratcheting means 269 has an axis of rotation 271 that is substantially parallel to imaginary lines 259 and 271 created by internal engaging surfaces 256 and 258 respectively. And, ratcheting means 269 is positioned within the rear portion 265 of handle 261. Positioning ratcheting means 269 at the rear portion of wrench handle 261 provides novel structural and functional benefits, whereas, the leverage forces applied to ratcheting means 269 are minimized. And, leverage forces are most minimized when the ratcheting means 269 is positioned at the rear end 267 of handle 261 as shown. This ensures that the ratcheting means 269 will not be adversely affected while high leverage forces are applied to handle 261 of hand tool 251, thus maximizing operational durability of ratcheting means 269.

Hand tool 253 also has a clamping means 275 which has a lever 277 pivotably connected to hand tool wrench 251 with pivot axle 279 to assist in the clamping of jaws 255 and 257 upon a work-piece such as a nut or bolt. Lever 277 is operated similarly to a traditional prior art “vise grip” locking pliers, but is adapted to work with the jaws of adjustable wrench 251. Release lever 281 is used by a user to release lever 277 and the clamping action of jaws 255 and 257 upon a work-piece.

FIG. 12 shows a left side elevational view of an example embodiment of a locking pliers that includes a clamping means to close and clamp its jaws upon a work-piece. Hand tool 351 has a hand tool head 353 and hand tool jaws 355 and 357. Jaws 355 and 357 each have at least one internal engaging surface for engaging with a work-piece such as a nut or bolt having an axis of rotation. For example, jaw 355 has internal engaging surface 356; and, jaw 357 has internal engaging surface 358 as seen in this left side view of hand tool 351. In this embodiment of the present invention, the at least one internal engaging surface of each jaw extends in a direction creating an imaginary line when the hand tool 351 is viewed from a side view thereof. For example, internal engaging surface 358 of jaw 357 creates an imaginary line 359 as seen in this side view of hand tool 351. Hand tool 351 also has a handle 361 extending from tool head 353. Handle 361 has a front portion 363 and a rear portion 365; and, rear portion 365 has a rear end 367. Hand tool 351 also has a ratcheting means 369 providing ratcheting capability to tool head 353 when handle 361 is twisted back and forth by a user. Ratcheting means 369 has an axis of rotation 371 that is substantially parallel to imaginary line 359 created by internal engaging surface 358 of jaw 357 as seen in this side view of hand tool 351.

Hand tool 351 also has a clamping means 375 which has a lever 377 pivotably connected to hand tool 351 with pivot axle 379 to assist in the clamping of jaws 355 and 357 upon a work-piece such as a nut or bolt. Lever 377 is operated similarly to a traditional prior art “vise grip” locking pliers, to force-ably clamp jaws 355 and 357 upon a work-piece. Release lever 381 is used by a user to release lever 377 and the clamping action of jaws 355 and 357 upon a work-piece. Adjustment knob 383 is turned clockwise or counter-clockwise to adjust the distance and clamping pressure between jaws 355 and 357.

Upon reading and understanding the specification of the present invention described above, modifications and alterations will become apparent to those skilled in the art. It is intended that all such modifications and alterations be included insofar as they come within the scope of the patent as claimed or the equivalence thereof.

What is claimed:

1. A hand tool comprising:
A tool head having at least two jaws, each said jaw having at least one internal engaging surface for engaging with a work-piece such as a nut or bolt having an axis of rotation, the at least one internal engaging surface of each said jaw extending in a direction creating an imaginary line when said hand tool is viewed from a side view thereof; and,
a handle extending from said tool head, said handle having a front portion and a rear portion, said handle rear portion including a rear end; and,
a ratcheting means providing ratcheting capability to said tool head when said handle is twisted back and forth by a user, said ratcheting means having an axis of rotation being substantially parallel to the imaginary line created by the at least one internal engaging surface of at least one said jaw when said hand tool is viewed from a side view thereof, and, said ratcheting means being positioned within the rear portion of said handle.

2. The hand tool according to claim 1, wherein, the axis of rotation of said ratcheting means is substantially parallel to the imaginary line created by the at least one internal engaging surface of each said jaw when said hand tool is viewed from a side view thereof.

3. The hand tool according to claim 1, wherein said handle is elongated with at least one central axis being substantially parallel to the imaginary line of the at least one engaging surface of at least one said jaw of said hand tool head when said hand tool is viewed from a side view thereof.

4. The hand tool according to claim 1, wherein said handle is elongated with at least one central axis being substantially parallel to the imaginary line of the at least one engaging surface of each said jaw of said tool head when said hand tool is viewed from a side view thereof.

5. The hand tool according to claim 1, wherein the at least one engaging surface of at least one said jaw is non-smooth so as to increase the coefficient of friction between the at least one engaging surface and a work-piece to prohibit the tool jaws from slipping off the work-piece while the ratcheting means is utilized by a user.

6. The hand tool according to claim 1, wherein the ratcheting means is positioned at the rear end of said tool handle.

7. The hand tool according to claim 2, wherein said handle is elongated with at least one central axis being substantially parallel to the imaginary line of the at least one engaging surface of at least one said jaw of said hand tool head when said hand tool is viewed from a side view thereof.

8. The hand tool according to claim 2, wherein said handle is elongated with at least one central axis being substantially parallel to the imaginary line of the at least one engaging surface of each said jaw of said tool head when said hand tool is viewed from a side view thereof.

9. The hand tool according to claim 2, wherein the at least one engaging surface of at least one said jaw is non-smooth so as to increase the coefficient of friction between the at least one engaging surface and a work-piece to prohibit the hand tool jaws from slipping off the work-piece while the ratcheting means is utilized by a user.

10. The hand tool according to claim 2, wherein the ratcheting means is positioned at the rear end of said tool handle.

11. A hand tool comprising:
A tool head having at least two jaws, each said jaw having at least one internal engaging surface for engaging with a work-piece such as a nut or bolt having an axis of rotation, the at least one internal engaging surface of each said jaw extending in a direction creating an imaginary line when said hand tool is viewed from a side view thereof; and,
a handle extending from said tool head, said handle having a front portion and a rear portion, said handle rear portion including a rear end; and,
a ratcheting means providing ratcheting capability to said tool head when said handle is twisted back and forth by a user, said ratcheting means having an axis of rotation being substantially parallel to the imaginary line created by the at least one internal engaging surface of at least one said jaw when said hand tool is viewed from a side view thereof, said ratcheting means being positioned within the rear portion of said handle; and,
said hand tool further comprising a clamping means to close and clamp said jaws upon said work-piece.

12. The hand tool according to claim 11, wherein, the axis of rotation of said ratcheting means is substantially parallel to the imaginary line created by the at least one internal engaging surface of each said jaw when said hand tool is viewed from a side view thereof.

13. The hand tool according to claim 11, wherein said handle is elongated with at least one central axis being substantially parallel to the imaginary line of the at least one engaging surface of at least one said jaw of said hand tool head when said hand tool is viewed from a side view thereof.

14. The hand tool according to claim 11, wherein said handle is elongated with at least one central axis being substantially parallel to the imaginary line of the at least one engaging surface of each said jaw of said tool head when said hand tool is viewed from a side view thereof.

15. The hand tool according to claim 11, wherein the at least one engaging surface of at least one said jaw is non-smooth so as to increase the coefficient of friction between the at least one engaging surface and a work-piece to prohibit the tool jaws from slipping off the work-piece while the ratcheting means is utilized by a user.

16. The hand tool according to claim 11, wherein the ratcheting means is positioned at the rear end of said tool handle.

17. The hand tool according to claim 11, wherein the clamping means of said hand tool includes a lever pivotably attached to said hand tool.

18. The hand tool according to claim 12, wherein the at least one engaging surface of at least one said jaw is non-smooth so as to increase the coefficient of friction between the at least one engaging surface and a work-piece to prohibit the tool jaws from slipping off the work-piece while the ratcheting means is utilized by a user.

19. The hand tool according to claim 12, wherein the ratcheting means is positioned at the rear end of said tool handle.

20. The hand tool according to claim 12, wherein the clamping means of said hand tool includes a lever pivotably attached to said hand tool.
